(19) United States
(12) Patent Application Publication
(10) Pub. No.: US 2015/0100682 A1
(43) Pub. Date: Apr. 9, 2015

(54) INFORMATION PROVIDING APPARATUS AND METHOD, INFORMATION PROVIDING SYSTEM, AND NON-TRANSITORY COMPUTER READABLE MEDIUM

(71) Applicant: FUJI XEROX CO., LTD., Tokyo (JP)

(72) Inventor: Yoshihiro UEDA, Kanagawa (JP)

(73) Assignee: FUJI XEROX CO., LTD., Tokyo (JP)

(21) Appl. No.: 14/267,252

(22) Filed: May 1, 2014

(30) Foreign Application Priority Data
Oct. 7, 2013 (JP) 2013-210381

(51) Int. Cl. H04L 12/26

(52) U.S. Cl. CPC H04L 43/04
USPC 709/224

(57) ABSTRACT

An information providing apparatus includes a collecting unit, a generating unit, and an output unit. The collecting unit collects log information of a service execution apparatus managed in an intranet and log information of a service execution apparatus managed outside the intranet. The generating unit generates analysis information by integrating the log information inside and outside the intranet on the basis of user information included in the log information in the intranet and the log information outside the intranet. The output unit outputs the analysis information generated by the generating unit.

### CROSS-REFERENCE TO RELATED APPLICATIONS

This application is based on and claims priority under 35 USC 119 from Japanese Patent Application No. 2013-210381 filed Oct. 7, 2013.

### BACKGROUND

(i) Technical Field

The present invention relates to an information providing apparatus and method, an information providing system, and a non-transitory computer readable medium.

(ii) Related Art

Hitherto, documents to be provided to customers are generally printed by a printer or a multi-functional machine located in an office and then brought to the customers. Nowadays, however, there are not a few cases in which a document is printed by a multi-functional machine located in a convenience store in the neighborhood of a customer and then brought to the customer. When printing is performed in-house, log information recorded as the actual printing record is accumulated in a print server that controls execution of in-house print services. In contrast, when printing is performed outside the office, log information is accumulated in a print management server located in a management company that manages print services outside the office.

### SUMMARY

According to an aspect of the invention, there is provided an information providing apparatus including a collecting unit, a generating unit, and an output unit. The collecting unit collects log information of a service execution apparatus managed in an intranet and log information of a service execution apparatus managed outside the intranet. The generating unit generates analysis information by integrating the log information inside and outside the intranet on the basis of user information included in the log information in the intranet and the log information outside the intranet. The output unit outputs the analysis information generated by the generating unit.

### BRIEF DESCRIPTION OF THE DRAWINGS

An exemplary embodiment of the present invention will be described in detail based on the following figures, wherein:

FIG. 1 is a block diagram illustrating the overall configuration of an information providing system according to an exemplary embodiment of the present invention and each apparatus included in the information providing system;

FIG. 2 is a hardware block diagram of a computer forming a log information providing apparatus in this exemplary embodiment;

FIG. 3 is a flowchart illustrating a log information collecting process in this exemplary embodiment;

FIG. 4 is a diagram illustrating an exemplary data configuration of log information accumulated in a log information accumulating unit in this exemplary embodiment;

FIG. 5 is a diagram illustrating an exemplary screen display that is generated in this exemplary embodiment and that displays, in a graph, analysis information indicating the relationship between customers and the number of times printing is performed;

FIG. 6 is a diagram illustrating an exemplary screen display that is generated in this exemplary embodiment and that displays, in a graph, analysis information indicating the relationship between the customers and costs;

FIG. 7 is a diagram illustrating an exemplary screen display that is generated in this exemplary embodiment and that displays, on a map, analysis information indicating the relationship between the customers and the number of times printing is performed;

FIG. 8 is a diagram illustrating the result of a simulation conducted regarding changing of a contract plan on the analysis information displayed in FIG. 5; and

FIG. 9 is a diagram illustrating the result of a simulation conducted regarding changing of a print execution place on the analysis information displayed in FIG. 8.

### DETAILED DESCRIPTION

Hereinafter, an exemplary embodiment of the present invention will be described on the basis of the drawings.

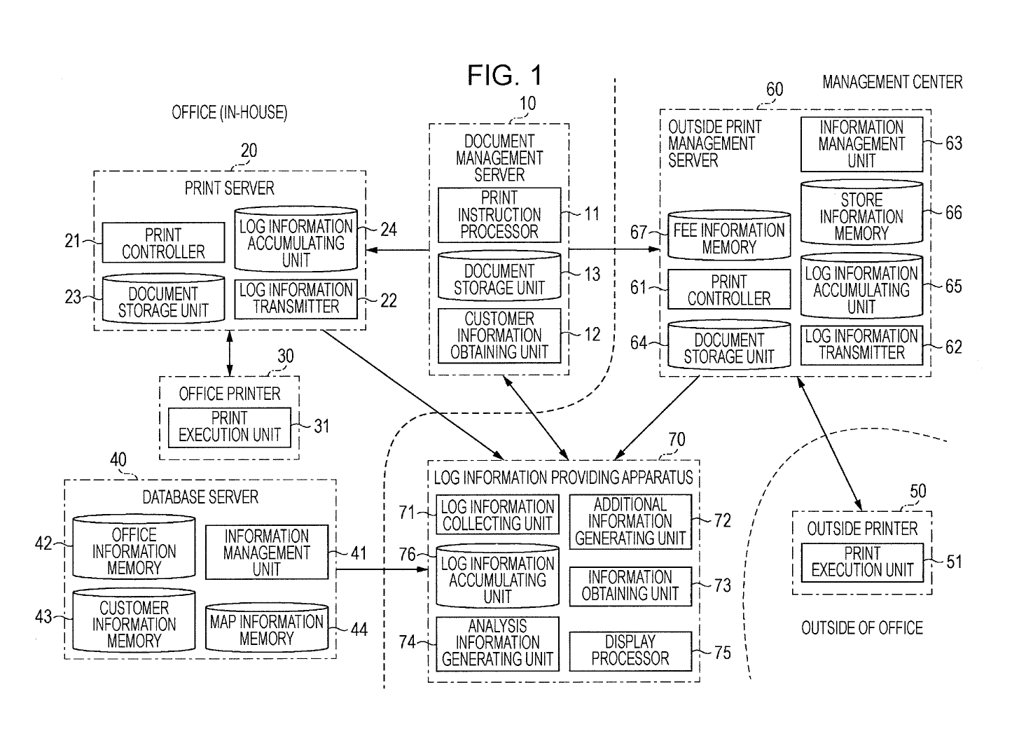

FIG. 1 is a block diagram illustrating the overall configuration of an information providing system according to an exemplary configuration of the present invention. FIG. 1 also illustrates the block configuration of each apparatus included in the information providing system, which is a log information providing system. FIG. 1 illustrates a document management server 10, a print server 20, an office printer 30, and a database server 40 that are located in an office, an outside printer 50 located outside the office, and an outside print management server 60 and a log information providing apparatus 70 that are located in a management server outside the office. The document management server 10, the print server 20, the database server 40, the outside print management server 60, and the log information providing apparatus 70 are interconnected via a wide area network (WAN) such as the Internet that is not illustrated in the drawings. The outside print management server 60 and the log information providing apparatus 70 may be interconnected via a local area network (LAN). The document management server 10, the print server 20, the office printer 30, and the database server 40 are formed in an intranet that is an in-house network. Although it is assumed that the document management server 10, the print server 20, the office printer 30, and the database server 40 are interconnected via a LAN (not illustrated), these apparatuses may be interconnected via a WAN or a combination of a WAN and a LAN.

The office is a business operation where users that execute printing are. The management center is an information center of a management company that manages this system. The log information providing apparatus 70 located in the management center is an example of an information providing apparatus according to an exemplary embodiment of the present invention and is an apparatus that is used to integrate and manage log information by collecting log information generated in response to printing executed in the intranet (in the office) or outside the intranet (outside the office) and to provide information such as the analysis result to users or the like by analyzing the integrated log information. The term “outdoor” refers to being outside the office. In this exemplary embodiment, it is assumed to apply this system to the case in which a sales representative or the like (“user” hereinafter) who is employed by the business operation prints an electronic document with the office printer 30 or the outside printer 50 and brings the printed document to a certain customer.

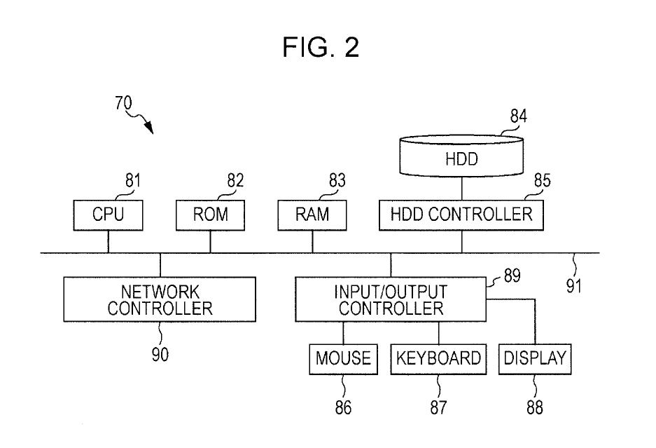

FIG. 2 is a hardware block diagram of a computer forming the log information providing apparatus 70 in this exemplary embodiment. In this exemplary embodiment, a computer forming the log information providing apparatus 70 is realizable with the hardware configuration of a general personal computer (PC) that has been available before. That is, the computer is configured by connecting, as illustrated in FIG. 2, a central processing unit (CPU) 81, a read-only memory (ROM) 82, a random-access memory (RAM) 83, a hard disk drive (HDD) controller 85 to which an HDD 84 is connected, an input/output controller 89 connected to a mouse 86 and a keyboard 87 that are provided as an input unit and to a display 88 that is provided as a display device, and a network controller 90 that is provided as a communication unit to an internal bus 91.

Since the document management server 10, the print server 20, the database server 40, and the outside print management server 60 are similarly computers, they may be illustrated as in FIG. 2.

The office printer 30 and the outside printer 50 are image forming apparatuses that at least have a print function and are apparatuses including a computer. That is, each of the office printer 30 and the outside printer 50 includes a CPU, a ROM, a RAM, and an HDD, and performs operation control of various mechanisms included in this apparatus, such as a scanner and a printer engine, in accordance with a program stored in the ROM. Further, each of the office printer 30 and the outside printer 50 has an operation panel, an integrated circuit (IC) card reader, a network interface, and an external media interface connected to an external memory device such as a Universal Serial Bus (USB) memory. The office printer 30 and the outside printer 50 may be realized with a general hardware configuration. Note that the outside printer 50 is connected to a fee charging device and has a function of collecting a fee upon use.

Referring back to FIG. 1, the document management server 10 includes a print instruction processor 11, a customer information obtaining unit 12, and a document storage unit 13, manages an electronic document to be printed, and processes a print instruction for each such document. The user gives a print instruction to the document management server 10 using an information processing apparatus (not illustrated) such as a PC at his/her desk or a mobile information terminal. The document storage unit 13 stores an electronic document to be printed. The print instruction processor 11 executes a print instruction process on a document selected by the user from among documents stored in the document storage unit 13 in response to a print instruction from the user. The customer information obtaining unit 12 obtains customer information regarding a customer serving as a providing destination of the document for which the print instruction has been given (destination to which the user brings the document).

The print server 20 is provided as an in-house service server, includes a print controller 21, a log information transmitter 22, a document storage unit 23, and a log information accumulating unit 24, and performs print control of the office printer 30. The user selects the office printer 30 or the outside printer 50 as a print execution destination of a document. The print controller 21 performs print control in the case where the office printer 30 is selected as a print execution destination. The document storage unit 23 stores a document that is specified by the user as a document to be printed and that is transmitted from the document management server 10. When printing is executed, the log information accumulating unit 24 accumulates log information regarding this print execution, which is generated by the print controller 21. The log information transmitter 22 transmits log information accumulated in the log information accumulating unit 24 to the log information providing apparatus 70.

The office printer 30 is a printer that executes printing and includes a print execution unit 31 that executes printing of a document specified in accordance with an operation instruction from the user. Although only one office printer 30 is illustrated in FIG. 1 for the sake of convenience because it is sufficient for the office printer 30 to have an equivalent function, multiple office printers 30 may be provided in the office.

The database server 40 includes various databases such as an office information memory 42 storing office information regarding each office, such as the name and place, a customer information memory 43 storing customer information regarding each customer, such as the name and place, and a map information memory 44 storing map information and information regarding modes of transport (route information, fare, etc.). An information management unit 41 manages these items of information such as updating and provides these items of information in response to access from the outside.

The print instruction processor 11, the customer information obtaining unit 12, the print controller 21, the log information transmitter 22, the print execution unit 31, and the information management unit 41 are realized by cooperation between a computer forming each of the apparatuses and a program operating on a CPU included in the computer. In addition, each of the document storage unit 13, the document storage unit 23, the log information accumulating unit 24, the office information memory 42, the customer information memory 43, and the map information memory 44 is realized by an HDD included in each apparatus. Alternatively, an RAM or an external memory may be used via a network.

The outside printer 50 is a printer that executes printing and includes a print execution unit 51 that executes printing of a document specified in accordance with an operation instruction from the user. Only one outside printer 50 is illustrated in FIG. 1 for the sake of convenience because it is sufficient for the outside printer 50 to have an equivalent function. It is assumed that the outside printer 50 in this exemplary embodiment is a printer that is located in a store such as a convenience store under contract with the management company and is usable by a user who pays a fee. The print execution unit 51 is realized by cooperation between a computer included in the outside printer 50 and a program operating on a CPU included in the computer.

The outside print management server 60 is provided as an outside service server, includes a print controller 61, a log information transmitter 62, an information management unit 63, a document storage unit 64, a log information accumulating unit 65, a store information memory 66, and a fee information memory 67, and performs print control of the outside printer 50. The print controller 61 performs print control in the case where the outside printer 50 is selected as a print execution destination. The document storage unit 64 stores a document that is specified by the user as a document to be printed and that is transmitted from the document management server 10. When printing is executed, the log information accumulating unit 65 accumulates log information regarding this print execution, which is generated by the print controller 61. The log information transmitter 62 transmits log information accumulated in the log information accumulating unit 65 to the log information providing apparatus 70. The information management unit 63 manages items of information stored in the store information memory 66 and the fee information memory 67 such as updating and provides these items of information in response to access from the outside. The store information memory 66 stores information regarding the outside printer 50 managed by the management company and the store where the outside printer 50 is located. Specifically, information such as the model number serving as the identification information of the outside printer 50 located in the store, an IP address, usable sheet sizes, whether monochrome/color printing is available, the place of the store, and the like is stored. The place of the store is the address and/or longitude and latitude information. The fee information memory 67 stores information regarding fees related to printing. Specifically, information such as the unit fee according to each sheet size and monochrome/color printing, information regarding volume discount, and the like is stored. In addition, the management company may hold a price plan contract with a company when allowing the company to use the outside printer 50. The details of settings of the price plan and the details of a contract with each company are also stored in the fee information memory 67.

The elements 61 to 63 of the outside print management server 60 are realized by cooperation between a computer forming the outside print management server 60 and a program operating on a CPU included in the computer. In addition, each of the memories 64 to 67 is realized by an HDD included in the outside print management server 60. Alternatively, a RAM or an external memory may be used via a network.

The log information providing apparatus 70 in this exemplary embodiment includes a log information collecting unit 71, an additional information generating unit 72, an information obtaining unit 73, an analysis information generating unit 74, a display processor 75, and a log information accumulating unit 76. The log information collecting unit 71 is provided as a collecting unit, collects in-house log information of an in-house service execution apparatus managed in the intranet, that is, log information upon execution of a print service by the office printer 30 that is an in-house service execution apparatus, and outside log information of an outside service execution apparatus managed outside the intranet, that is, log information upon execution of a print service by the outside printer 50 that is an outside service execution apparatus, and registers the log information in the log information accumulating unit 76, thereby storing the log information. The additional information generating unit 72 and the information obtaining unit 73 are provided as an obtaining unit. Among these units, the additional information generating unit 72 generates, as additional information, information necessary for analyzing log information, and adds the additional information to corresponding log information accumulated in the log information accumulating unit 76. The information obtaining unit 73 obtains, from the outside, information necessary for generating additional information by the additional information generating unit 72. Specifically, the information obtaining unit 73 obtains the position information of a service providing destination to which a printed matter (document) is provided, and information regarding a fee charged at the outside printer 50. The analysis information generating unit 74 is provided as a generating unit and generates integrated analysis information on the basis of user information included in log information accumulated in the log information accumulating unit 76. Note that, as analysis information, information indicating the relationship between the execution place of a service, that is, the location of each of the office printer 30 and the outside printer 50, and a destination to which a printed document is provided is also generated. The display processor 75 is provided as an output unit and displays analysis information generated by the analysis information generating unit 74 on the display 88. The log information accumulating unit 76 accumulates log information generated in response to print services executed inside and outside the office.

The elements 71 to 75 of the log information providing apparatus 70 are realized by cooperation between a computer forming the log information providing apparatus 70 and a program operating on a CPU 81 included in the computer. In addition, the log information accumulating unit 76 is realized by an HDD 84 included in the log information providing apparatus 70. Alternatively, an external memory may be used via a network.

In addition, a program used in this exemplary embodiment may be provided by a communication unit or may be stored in a computer readable recording medium such as a compact-disc (CD)-ROM or a digital versatile disc (DVD)-ROM and provided. A program provided by a communication unit or from a recording medium is installed in a computer, and a CPU of the computer sequentially executes the program, thereby realizing various processes.

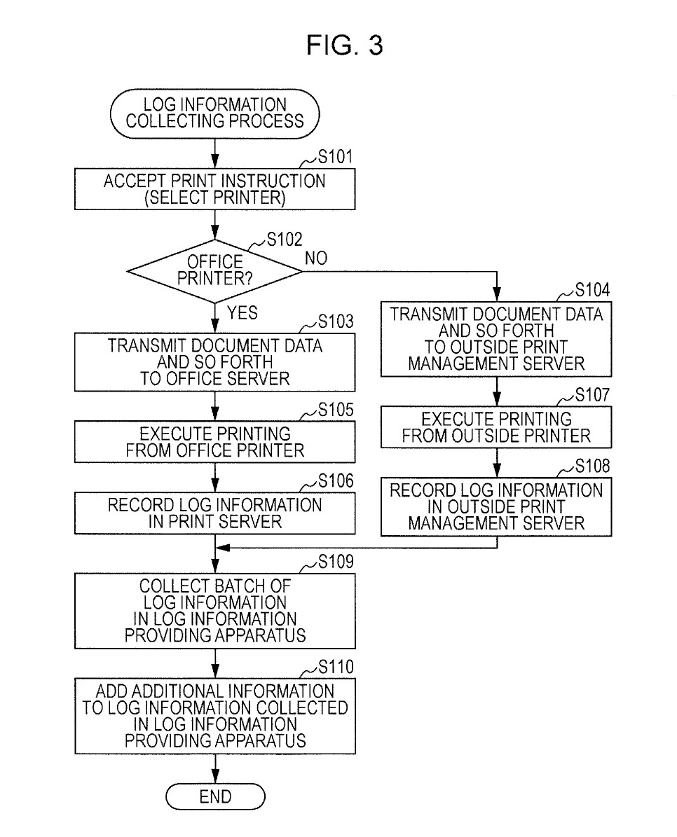

Next, the operation in this exemplary embodiment will be described. First, a log information collecting process from when a user gives a print instruction to when log information is collected in the log information providing apparatus 70 will be described using the flowchart illustrated in FIG. 3.

A user who performs printing of a document accesses the document management server 10 using, for example, his/her information terminal in an office, and gives an instruction to print the document. At this time, the user selects a document to be printed and the office printer 30 or the outside printer 50 as a print execution destination (document output destination) (step S101). In the case where multiple office printers 30 or outside printers 50 are located, a list of printers transmitted from the document management server 10 may be displayed on a display of the information terminal used to give a print instruction, and the user may be prompted to select one from the list. The information terminal used to give a print instruction transmits the user ID of the user, in addition to information for identifying a document specified by the user and a printer at the print execution destination, to the document management server 10. Further, in order to identify a place where the user has given a print instruction, the document management server 10 is notified of the print instruction place using the GPS function of the information terminal or an email sent by the user, thereby giving a notification of information for identifying a place where the user has given a print instruction (place where the user is).

In the case where the office printer 30 is selected (Y in step S102), the print instruction processor 11 of the document management server 10 transmits a set of document data to be printed (such as portable document format (PDF)), document ID, and user ID to the print server 20 (step S103). In response to this, the print server 20 registers the transmitted information in the document storage unit 23. In contrast, in the case where the outside printer 50 is selected (N in step S102), the print instruction processor 11 of the document management server 10 transmits a set of document data to be printed (such as PDF), document ID, and user ID to the outside print management server 60. In response to this, the outside print management server 60 registers the transmitted information in the document storage unit 64.

Thereafter, the user who has selected the office printer 30 moves to a place where the office printer 30 is located, with which the user wants to perform printing. When user authentication is performed from the office printer 30, the office printer 30 transmits the user ID to the print server 20. In response to this, the print server 20 reads a document ID(s) stored in association with the user ID from the document storage unit 23, sends a list of the read document ID(s) to the office printer 30, and displays the list on the operation panel. When the user selects a document from the document list, the print execution unit 31 of the office printer 30 obtains data of the document from the print server 20 and actually executes printing (step S105). When printing is executed, log information generated by the print controller 21 is accumulated in the log information accumulating unit 24 of the print server 20 (step S106).

In contrast, the user who has selected the outside printer 50 moves to a store such as a convenience store where the outside printer 50 is located, with which the user wants to perform printing. User authentication is performed from the outside printer 50, and the document ID of a document to be printed is input and specified. In response to this, the outside printer 50 transmits the user ID, the document ID, and further, as information for specifying the outside printer 50, a store ID to the outside print management server 60. In response to this, the print controller 61 of the outside print management server 60 reads document data of the specified document ID from the document storage unit 64, and transmits the read document data to the outside printer 50 identifiable from the store ID. The print execution unit 51 of the outside printer 50 obtains the document data from the outside print management server 60 and actually executes printing (step S107). When printing is executed, log information generated by the print controller 61 is accumulated in the log information accumulating unit 65 of the outside print management server 60 (step S108).

In the above-described manner, log information is accumulated in each of the print server 20 and the outside print management server 60 as printing is executed. The function of each of the print server 20 and the outside print management server 60 to collect log information may be the same as or similar to that of the related art.

When log information is accumulated as above in each of the print server 20 and the outside print management server 60, the log information collecting unit 71 of the log information providing apparatus 70 collects the log information from each of the print server 20 and the outside print management server 60, and stores the log information in the log information accumulating unit 76 (step S109). The log information may be collected in real time or may be collected on a fixed cycle such as once a day.

Further, the additional information generating unit 72 generates additional information as information necessary for generating analysis information, adds the additional information to corresponding log information, and stores the added result in the log information accumulating unit 76 (step S110). The contents of the additional information will be described below.

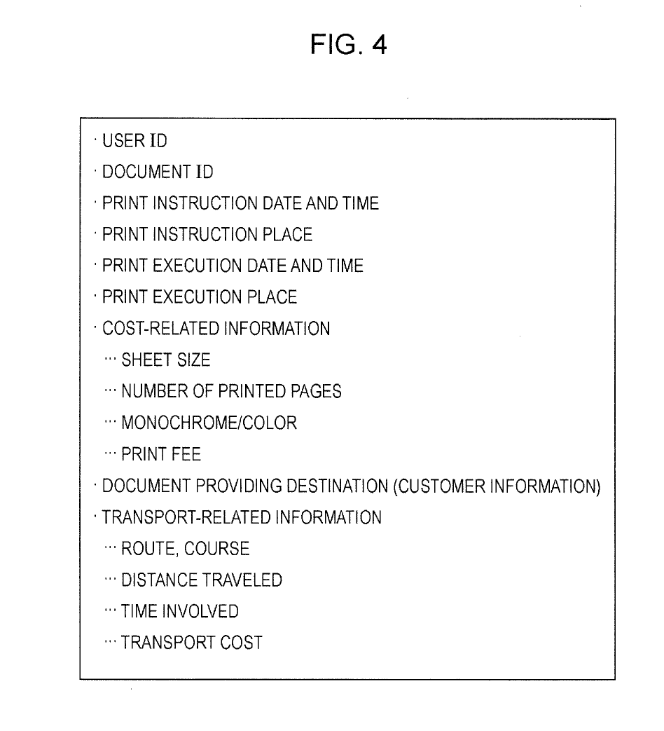

FIG. 4 is a diagram illustrating an exemplary data configuration of log information accumulated in the log information accumulating unit 76 in this exemplary embodiment. Here, log information accumulated in the log information providing apparatus 70 in this exemplary embodiment will be described.

Log information includes a user ID, the document ID of a printed document, information for identifying a date and time (print instruction date and time) and place (print instruction place) where a print instruction has been given, information for identifying a date and time (print execution time and date) and place (print execution place) where printing has been executed, and cost-related information. These items of information are included in log information collected from each of the print server 20 and the outside print management server 60 and is integrated and managed according to the user ID serving as user information for identifying the user. If user information used outside the office is separately used from user information used inside the office, that is, if user information for in-house use is different from user information for outside use, information for associating these items of user information may be retained, and this retained information may be referred to upon integrating the log information. In addition, as information for identifying a place where printing has been executed, the name of the office is set if printing is performed inside the office; the name of the store where the outside printer 50 is located is set if printing is performed outside the office.

The cost-related information is information related to costs involved in execution of printing performed by each of the office printer 30 and the outside printer 50. In the case where the user uses the outside printer 50 to execute printing, the cost-related information includes the size of each sheet used in printing, the number of printed pages according to each sheet size, and whether monochrome or color mode printing is performed according to each sheet, along with a print fee charged to the user. In the case where the user uses the office printer 30 to execute printing, as with the case of the outside printer 50, the cost-related information includes a sheet size(s), the number of printed pages, and whether monochrome or color mode printing is performed. In the case of in-house use, a print fee is unnecessary since fees are generally not charged to users. Unlike the outside printer 50, the office printer 30 involves fixed costs such as fixed assets, and consumable supplies expenses. Thus, on the basis of this information, an in-house print fee is calculated to be contrasted to an outside print fee.

A document providing destination is customer information regarding a customer serving as a destination to which a user brings and provides a document (printed matter) obtained by execution of printing. The customer information includes at least one of the customer name, place, and the like. A customer serving as a document providing destination may be identified by a user input from a certain screen at the time printing is executed, or the print server 20 or the outside print management server 60 may be notified by the user using an email or the like. In addition, in the case where an electronic document in the document management server 10 is classified and managed in a folder to which information capable of identifying a customer such as a customer name is attached, the customer may be identified from the folder name. Alternatively, a document to be printed may be subjected to character analysis at the time printing is executed, and a customer name described in the document may be extracted. A document providing destination is obtained by giving an instruction from the additional information generating unit 72 to the customer information obtaining unit 12.

Transport-related information includes information regarding a user's transport from his/her office to a customer. A route or course includes the transport path from the office to the customer, which is identified on the basis of the document providing destination, and modes of transport such as by walking, train, bus, and the like. In a distance traveled, a distance traveled from the office to the customer, which is identified on the basis of the document providing destination, is set. In a time involved, a time involved in transport from the office to the customer, which is identified on the basis of the document providing destination, is set. A transport cost includes a cost involved in transport from the office to the customer, which is identified on the basis of the document providing destination. If a train is used, for example, a train fare is included.

Transport-related information is not information on the actual transport, but is obtained by identifying an optimal route and calculating a time, distance, and cost involved in transport in accordance with the identified route. Therefore, in this exemplary embodiment, in the case where no longitude and latitude information is included in a print instruction place or a print execution place, the longitude and latitude information of a print instruction place and a print execution place is obtained by referring to office information, customer information, and map information retained and managed in the database server 40, and by further referring to store information retained and managed in the outside print management server 60, thereby obtaining a route, a distance traveled, and the like. Specifically, the additional information generating unit 72 of the log information providing apparatus 70 obtains the longitude and latitude information of a place where printing has been executed by causing the information obtaining unit 73 to refer to office information stored in the database server 40 or store information stored in the outside print management server 60. In addition, the additional information generating unit 72 identifies an optimal route and modes of transport by causing the information obtaining unit 73 to refer to map information stored in the database server 40, and obtains a time and cost involved when these modes of transport are used. Note that map information may not necessarily be in-house map information, and an external map information system may be used.

In this manner, the additional information generating unit 72 generates and obtains a document providing destination and transport-related information as additional information, and stores the additional information in the log information accumulating unit 76 in association with each item of log information collected from each of the print server 20 and the outside print management server 60.

Note that, in this exemplary embodiment, a document providing destination is generated by the customer information obtaining unit 12 of the document management server 10. This is because, in the case where customer name is obtained by subjecting a document to character analysis, the document itself is retained not by the log information providing apparatus 70, but by the document management server 10. In addition, although the longitude and latitude information of each place is obtained by proactive operation of the additional information generating unit 72, the print server 20 and the outside print management server 60 may obtain the longitude and latitude information of each place as a print execution place and may include the obtained information in log information to be transmitted to the log information providing apparatus 70.

In an analysis information display process described later, analysis information is generated by referring to log information stored in the log information accumulating unit 76 and is displayed. In this exemplary embodiment, the additional information generating unit 72 is provided, and information that is insufficient for generating analysis information, just with log information alone collected from each of the print server 20 and the outside print management server 60, is additionally generated and included in log information.

Next, displaying of analysis information generated on the basis of log information will be described using some display examples.

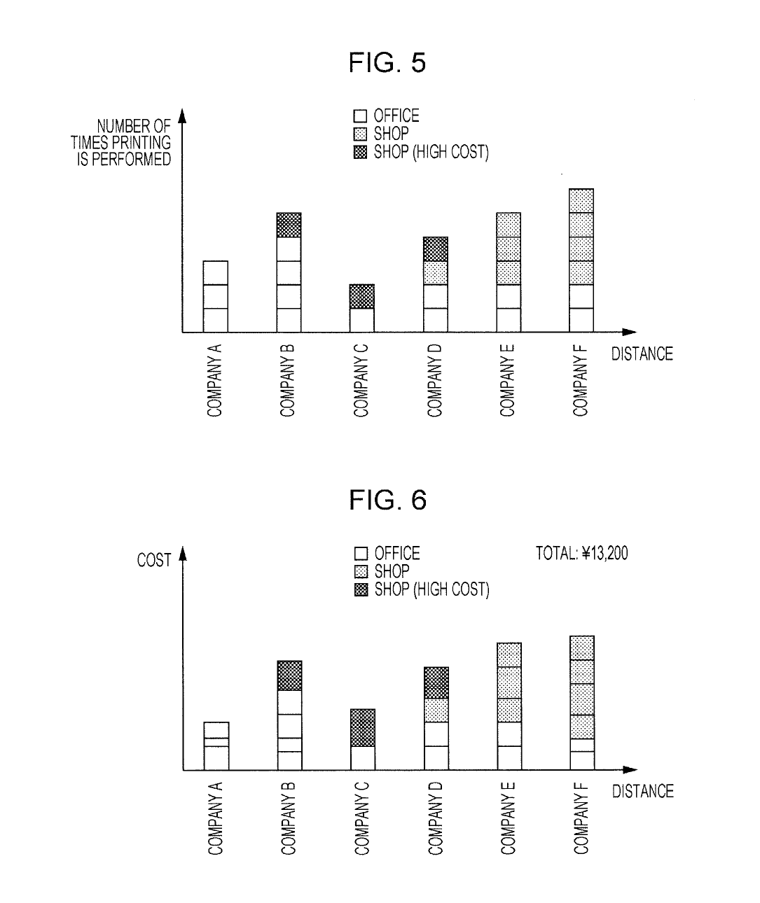

FIG. 5 is a diagram illustrating an example of the analysis information. The distance from the office to the place of each customer is plotted in abscissa, and the number of times printing is performed to provide a document to each customer in a certain period is plotted in ordinate of the graph illustrated in FIG. 5. According to the example illustrated in FIG. 5, companies A to F are located in places farther away from the office in this order. Each customer refers to a distance traveled included in log information and is plotted at a position on a horizontal line of the graph in accordance with the distance traveled. In addition, the number of times printing is performed corresponds to the number of items of log information aggregated according to each document providing destination in a certain period.

In addition, in FIG. 5, whether printing has been performed in-house (in the office) or outside the office (store) is separately displayed. Further, in the case of outside printing, if the cost is higher than that in the case of in-house printing, a difference from the case in which the cost of outside printing is not higher than the cost of in-house printing is separately displayed. Regarding the cost, it is sufficient to refer to a print fee in log information. A calculation method regarding the cost in the case where printing is not actually performed in-house will be described later. From this diagram, it is clear that users tend to execute printing outside the office instead of in the office for customers at great distances from the office. In addition, which of the office and the store is more expensive is additionally displayed as information regarding the cost.

Although blocks each indicating printing at one time have the same size in FIG. 5 in order to indicate the number of times printing is performed, blocks may have different heights in accordance with the number of printed pages, thereby indicating the amount of printing according to each customer.

FIG. 6 is a diagram illustrating another example of the analysis information. As in FIG. 5, the distance from the office to the place of each customer is plotted in abscissa, and the cost involved in printing executed to provide a document to each customer in a certain period is plotted in ordinate of the graph illustrated in FIG. 6. Regarding the cost, it is sufficient to refer to a print fee in log information. From this diagram, the total cost involved in each customer is made clear.

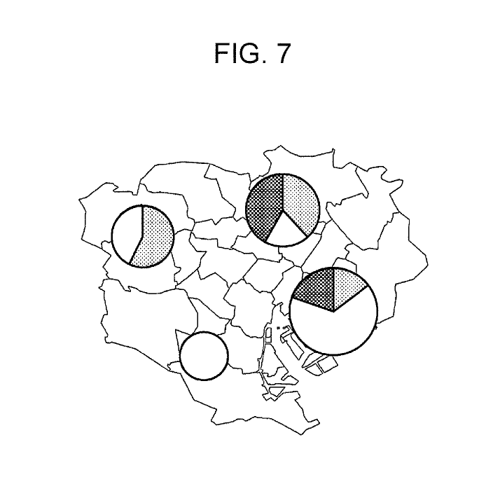

FIG. 7 is a diagram illustrating another example of the analysis information. In FIG. 5, the number of times printing is performed and the cost according to each customer are indicated using a bar graph. In FIG. 7, this is expanded as pie charts on a map. The pie charts are displayed with sizes in accordance with the number of times printing is performed, and, in each pie chart, the ratio among the office, store, and store (high cost) is indicated. The pie charts are displayed at positions on the map corresponding to the places of the customers. For the sake of convenience, information on not all the customers is displayed in FIG. 7.

In this manner, the number of times printing is performed may be displayed in association with the place of each customer. In addition, similar display may be performed in the case of the costs illustrated in FIG. 6, instead of the number of times printing is performed. In addition, specific numerals or details of log information may be displayed by positioning a cursor on a corresponding block or the like on a display screen illustrated by way of example in FIGS. 5 to 7. In addition, in the case where information is displayed on a map as with the case illustrated in FIG. 7, the positions of the office, stores, and customers may be plotted on a map, and the details of office information and customer information may be displayed in response to positioning a cursor on these positions.

By the way, at the time a user who belongs to a company uses the outside printer 50, the company may hold a price plan contract with the management company. For example, it is assumed that two plans are set, namely, a basic plan in which there is no discount or general volume discount (discount rate) is applied, and a discount plan in which, although the base rate is higher than that of a basic plan, a higher discount rate is applied. A company whose print amount is relatively high may hold a discount plan contract in order to reduce the overall cost, expecting the discount effects of volume discount though the company pays a high base rate.

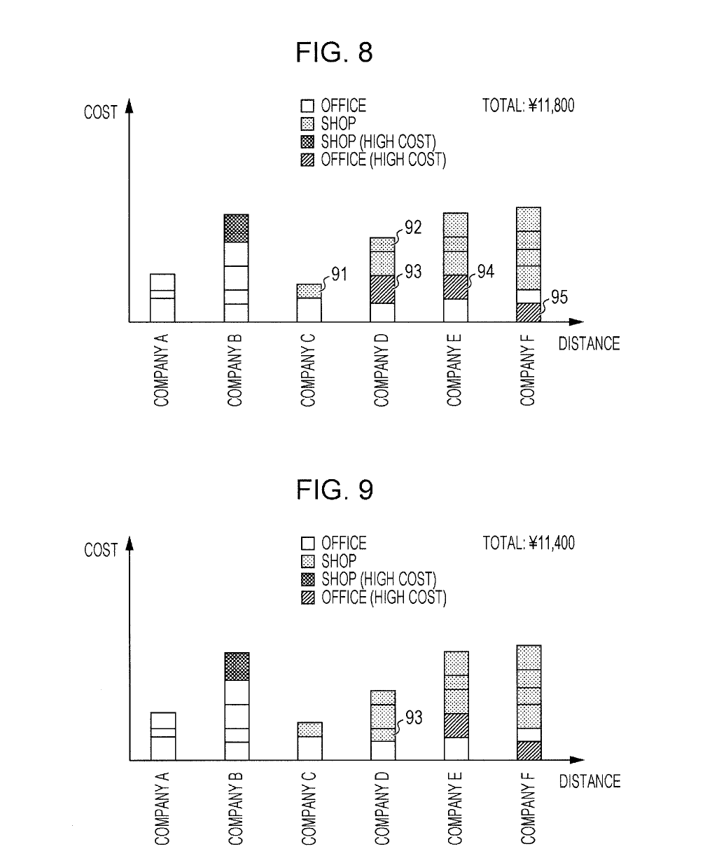

Here, it is assumed that FIG. 6 mentioned above illustrates analysis information at a company holding a basic plan contract. The result of executing a simulation in the case where this company changes the plan to a discount plan is illustrated in FIG. 8. Comparison between FIG. 6 and FIG. 8 makes it clear that, by changing the plan to a discount plan, for companies C and D, prints 91 and 92 appear in which, even when printing is performed at a store, the cost becomes cheaper than printing at the office. In contrast, it is made clear that, by changing the plan to a discount plan, for companies D, E, and F, prints 93, 94, and 95 appear in which the cost becomes cheaper when printing is performed at a store instead of the office. It is made clear that, when the discount plan is applied, the total cost within a certain period (such as January) is reduced from 13,200 yen to 11,800 yen. As a result, it is proved that this company saves money when holding a discount plan contract as long as referring to the cost of this month. When the manager or the like of this business operation refers to this result, the manager may change the details of the contract with the management company promptly or in accordance with the result of a similar simulation conducted in another period.

Since information regarding the price plan is stored in the fee information memory 67, in the case where an analyst selects to perform the above-described simulation on a certain simulation executing screen, the analysis information generating unit 74 causes the information obtaining unit 73 to obtain the price information and, on the basis of the obtained price information, executes the above-described simulation in a specified period.

By the way, as a result of the above-described simulation, by applying the discount plan, the prints 93, 94, and 95 appear in which the cost becomes cheaper when printing is performed at a store instead of the office. FIG. 9 is a diagram illustrating the result of a simulation in the case where the print 93 in FIG. 8 is changed from printing at the office to printing at a store. For example, when an analyst performs a certain print place changing operation such as double-clicking the block of the print 93, in response to this operation instruction, the analysis information generating unit 74 calculates a print fee in the case where printing of the print 93 is performed at a store and generates analysis information. Cost-related information in log information corresponding to the print 93 includes information necessary for calculating a charged fee, such as the size(s) of a printed sheet(s) and the number of printed pages according to each sheet size. Thus, the analysis information generating unit 74 refers to this cost-related information and calculates a print fee in the case where the print 93 is executed with the outside printer 50. In this exemplary embodiment, the function of obtaining a print fee for printing that is not actually performed is also provided.

Referring to FIG. 9, the print 93 is printed cheaper at a store than the office, and when reference is made to the total cost, it becomes clear that the cost becomes cheaper by 400 yen. In contrast to the actual records in FIG. 5, the manager of the business operation who has referred to analysis information displayed in FIGS. 8 and 9, which is obtained by executing a simulation, changes the details of the contract to a discount plan, and recognizes that the cost is expected to be reduced by giving priority to printing at a store over printing at the office.

In this exemplary embodiment, as has been described above, log information of printing in-house (inside the office) and printing outside the office (at a store) is collectively integrated and managed, and, on the basis of this integrated log information, the actual printing records inside and outside the office are provided in an integrated form.

Although the case in which the display processor 75 is provided as an output controller, and analysis information is displayed on the display processor 75 has been described in this exemplary embodiment, instead of the display processor 75 as an output controller or along with the display processor 75, another unit such as that for saving analysis information in a file format or providing information via a network may be provided.

Although it is necessary for the user to specify and select a period of log information to be displayed, the type of graph, and an index to be associated with each axis depending on the type of graph in order to display analysis information in the display format illustrated by way of example above, a user interface screen for such specification and selection is omitted since this is not a feature of the exemplary embodiment of the present invention.

In addition, although analysis information is generated by collectively organizing the print records of all users in this exemplary embodiment, analysis information may be generated according to each user. In addition, information regarding a document attribute such as the type of document may be additionally handled, and analysis information may be generated according to each document attribute.

In addition, although the case in which the printer is located as a service execution apparatus and is applied to a print service has been described by way of example in this exemplary embodiment, the printer may be applied to another service such as copying or facsimile sending.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information providing apparatus comprising:
a collecting unit that collects log information of a service execution apparatus managed in an intranet and log information of a service execution apparatus managed outside the intranet;
a generating unit that generates analysis information by integrating the log information inside and outside the intranet on the basis of user information included in the log information in the intranet and the log information outside the intranet; and
an output unit that outputs the analysis information generated by the generating unit.

2. The information providing apparatus according to claim 1, further comprising:
a memory that stores information for associating the user information included in the log information in the intranet with the user information included in the log information outside the intranet,
wherein the generating unit generates analysis information by integrating log information corresponding to user information associated by the associating information.

3. The information providing apparatus according to claim 1, further comprising:
an obtaining unit that obtains position information of each of the service execution apparatuses and position information of a service providing destination to which a service is provided by execution of the service by each of the service execution apparatuses,
wherein the generating unit generates analysis information indicating a relationship between a service execution place and a service providing destination on the basis of each of the items of log information collected by the collecting unit and each of the items of position information obtained by the obtaining unit.

4. The information providing apparatus according to claim 1,
wherein each of the items of log information includes information regarding a cost involved in execution of a service by a corresponding one of the service execution apparatuses, and
wherein the generating unit generates analysis information including the information regarding a cost involved in execution of a service.

5. The information providing apparatus according to claim 1,
wherein each of the items of log information includes information regarding a cost involved in execution of a service by a corresponding one of the service execution apparatuses, and
wherein the generating unit generates, as analysis information, a result of a simulation conducted on the basis of the information regarding a cost.

6. An information providing system comprising:
an in-house service server in which in-house log information upon execution of a service by a service execution apparatus located in an office is recorded;
an outside service server in which outside log information upon execution of a service by a service execution apparatus located outside the office is recorded;
a collecting unit that collects the log information recorded in each of the in-house service server and the outside service server;
a memory that integrates and stores the log information collected by the collecting unit;
a generating unit that generates integrated analysis information on the basis of user information included in the in-house log information and the outside log information;
an output unit that outputs the analysis information generated by the generating unit.

7. An information providing method comprising:
collecting log information of a service execution apparatus managed in an intranet and log information of a service execution apparatus managed outside the intranet;
generating analysis information by integrating the log information inside and outside the intranet on the basis of user information included in the log information in the intranet and the log information outside the intranet; and
outputting the generated analysis information.

8. A non-transitory computer readable medium storing a program causing a computer to execute a process for providing information, the process comprising:
collecting log information of a service execution apparatus managed in an intranet and log information of a service execution apparatus managed outside the intranet;
generating analysis information by integrating the log information inside and outside the intranet on the basis of user information included in the log information in the intranet and the log information outside the intranet; and
outputting the generated analysis information.
